(19) United States
(12) Patent Application Publication
(10) Pub. No.: US 2015/0256577 A1
(43) Pub. Date: Sep. 10, 2015

(54) Directing Fragmented Content

(71) Applicant: NICEPEOPLEATWORK S.L., Barcelona (ES)

(72) Inventors: Ferran GUTIÉRREZ VILARÓ, Barcelona (ES); Alberto José GONZÁLEZ CELA, Montcada i Reixac (ES)

(73) Assignee: NICEPEOPLEATWORK S.L., Barcelona (ES)

(21) Appl. No.: 14/198,391

(22) Filed: Mar. 5, 2014

(51) Int. Cl. H04L 29/06; H04L 29/08

(52) U.S. Cl. CPC H04L 65/4084; H04L 67/42; H04L 67/02

(57) ABSTRACT

Devices and methods of directing fragmented content, such as video or audio, to content players are disclosed. Requests are sent from content players to fragment directors to download fragmented content. The fragment directors identify, either internally or externally, content servers hosting said fragmented content. URLs corresponding to fragments of the fragmented content and pointing to different content servers are identified and selected by the fragment directors based on directing criteria. The URLs are provided to the content players. Therefore the fragmented content is balanced or switched on a fragment level among different content servers or groups of content servers.

### FIELD OF THE INVENTION

The present disclosure relates to multimedia and more specifically to methods and devices for directing fragmented content to content players.

### BACKGROUND

Content distribution systems typically include a content server, a content player, and any communications (e.g. mobile, fixed, IP or non-IP networks) network suitable for connecting the content server to the content player. The term “content server” is used in the present disclosure to denote a storage location for a particular digital content or resource. One skilled in the art may appreciate that any uniquely identifiable by a URL storage location for a particular fragment may serve as a “content server”. It may be in the form of a server, a group of servers, such as server farms or server clusters, of a CDN, or a caching system between a client and a server or a CDN or a cloud storage facility or any combination thereof. The content player may be configured to playback digital contents or resources, e.g., movies, televisions shows, sporting events, music productions, etc., as stored in a digital content file or provided as a byte-stream, e.g. live audio and/or video streams.

Typically, content server or a group of content servers may be configured within a communications network to form a content delivery/distribution network (CDN). In some configurations, the CDN may also include a directory server configured to provide a list of digital resources available from the CDN and associate each digital resource with a reference mechanism, such as a uniform resource locator (URL), used to access the resource. In other configurations the directory server may be external to the CDN and provide a list of content servers or a plurality of CDNs that may host the resource. When a user interacts with the content player to initiate playback of a specific resource, the content player may send a request to the directory server for a reference or list of references to content servers hosting the file or byte-stream. The content player then downloads and plays the resource, fully or partially, from the CDN using the references provided by the content directory server.

The digital resource may be hosted in the respective content server in a fragmented format, in fragments typically called “chunks” or “segments”. Each fragment or chunk may be self-contained and capable of being independently played back by the content player. Playback typically occurs using a technique known as “streaming,” where the content is transmitted over a communications network, e.g. WAN, LAN, PAN, WLAN, WiMAX, GSM, 3G, RF, LTE or any other type of network that may carry digital content, to the content player, which decodes and plays the media file while data is being received. To account for variable latency and bandwidth within the communications network, a content buffer queues some of the downloaded fragments ahead of the content data actually being played. During moments of network congestion, which leads to lower available bandwidth, less fragments are added to the buffer due to mainly packet delay or packet loss, which drains down as content data is being de-queued during streaming playback. However, during moments of low network congestion, the buffer is replenished, adding fragments to the buffer. In practical systems, the content buffer may queue content data corresponding to a time span ranging from seconds to more than a minute.

The playback quality of a program depends significantly on the bit-rate at which the video is encoded. In digital audio and video applications, bit rate refers to the number of data bits used per unit of playback time to represent audio and video. In general, the higher the bit-rate the higher the visual and auditory quality of a program and the longer it takes to download a portion of the program over a communication network at a fixed bandwidth or transmission rate. Accordingly, when the throughput that can be achieved using the network bandwidth available to a content player is high, then higher bit-rate encodings may be used for playback. Furthermore, the better the throughput of a connection, the less likely it is that a buffer under-run will occur (i.e., the less likely that streaming playback will be interrupted). This is particularly relevant for streaming media files over IP-based network connections, such as the Internet, were packets are sent in a best-effort delivery manner, and where quality of service is not guaranteed. However, during playback of a media file, the bandwidth and throughput conditions of a network may change and the throughput of the established connection between the content player and the content server may not be sufficient to account for a higher bit-rate streaming. As a result, multi-bit rate contents and sessions may be in place. That is, during playback, a content player may be required to switch between different bit-rates to maintain the continuity of the content playback using the best possible quality according to network conditions and player capabilities, thus affecting the quality of the play back. Furthermore, in certain cases it may be necessary to maintain the bit-rate, something that can cause lags in the playback of the content.

### SUMMARY

In a first aspect a method of directing a fragmented content to a content player is disclosed. The method comprises receiving a request at a fragment director from the content player to deliver said fragmented content to said content player; identifying a list of a plurality of content servers hosting a copy of said fragmented content; identifying one or more URLs for each fragment of said fragmented content, each URL corresponding to at least one of said content servers; selecting at least a first content server or group of content servers from the list of content servers to deliver at least a first fragment or group of fragments based on a first set of directing criteria; selecting at least a second content server or group of content servers from the list of content servers to deliver at least a second fragment or group of fragments based on a second set of directing criteria; providing the URLs of said at least first and second fragments or groups of fragments corresponding to the selected first and second content servers or groups of content servers, respectively, to the content player. In some implementations the fragment director may return URLs to the content player using a response message. For example, it may return an HTTP response message containing URLs in its body in any format like plain text, XML, JSON, etc. In other implementations, it may use inherent mechanisms of the communication protocol that is being used. For example it may use an HTTP message with, for instance, status codes such as redirect codes 302 or 301. An HTTP response message with these status codes will additionally provide a URL in the location header field of the message. By providing URLs that correspond to different servers, the traffic is balanced dynamically and intelligently among different content servers, sets of content servers or CDNs, at any given moment. In that way, technical issues, such as connection issues during the downloading of the content from one content server may be solved by directing the traffic to a second content server. Furthermore, motivation for directing content among a plurality of servers may also be non-technical considerations, such as pricing in one CDN over another. Said directing may involve balancing and/or switching of the content on a fragment level to the content player. Therefore, it is possible to direct the client to a different content server for each fragment or groups of fragments. For example, the directing may comprise initiating the downloading of fragments from a first content server or a first set of content servers and switching to another content server or set of content servers when an indication that the quality of service of the first content server or set of content servers begins to deteriorate. In other examples, the directing may be directly a balancing action from the beginning involving the dispatch of URLs, both main and redundant, that correspond to two or more content servers so that any momentary congestion at any one content server does not affect the downloading and the user experience. Said directing may be based on a set of criteria, predefined rules or algorithms or even be done in a random fashion, e.g. to spread the risk of congestion between a plurality of content servers or CDNs. The criteria may be the same for each content server or they may be different based on past experience. The process may reinitiate at each request or even during a session if, for example, certain characteristics of the session or of the connection may change. The directing criteria may be static or pre-established criteria. For example, they may force specific behaviors to the fragment directing by setting thresholds and hard limits to variables related to each downloading session. In other examples they may be dynamic, e.g. they may comprise rules that can change over time according to the variability of information or the status of both end-user connections or connections between network operators and CDNs. Typically, dynamic rules consider historical data gathered from monitoring systems, past decisions and/or apply learning mechanisms able to define new rules automatically. Furthermore, they may apply constraints or action assertions, such as, for example, conditions that the selected content server solution must satisfy. In some cases, even, such constraints may correspond to different laws or possible limitations applied by legal frameworks applicable in different territories. One such example constraint is a price for a connection that cannot be higher than a predetermined amount. Furthermore, they may be business rules, such as rules that define the way a business is controlled and operated.

The directing criteria are considered an input during the decision-making process in order to get the best or the most suitable output and alternative possible solutions to the problem of selecting the best content server or group of content servers at any given time.

In some embodiments said fragmented content may be video content and/or audio content. Directing fragmented content of this type from a plurality of content servers to the content player can minimize latency and/or improve the bit-rate and effective throughput that the content arrives at the content player, thus improving the playback experience for the user.

In some embodiments said selecting based on directing criteria may comprise assessing the traffic of the plurality of content servers or groups of content servers and classifying the content servers or groups of content servers based at least on said assessed traffic. Said classifying may be in the form of grouping, sorting or ranking based on a set of criteria. Therefore, it may be possible to select at any moment the best available content server and provide the corresponding URLs to the client. Furthermore, said providing of URLs may include the possibility of providing a plurality of URLs for the same fragment from the best available content servers based on said ranking. Therefore, if for any reason a content server is unavailable to the content player, the content player shall have readily available a backup or alternative content server URL to download the corresponding fragment or set of fragments.

In some embodiments said selecting based on directing criteria may comprise assessing the connection line between said content player and said first and second content server or groups of content servers and ranking the content servers based at least on the said assessing of a connection channel between said content player and a network service provider that gives access to the content player to the content server or groups of content servers. These may include characteristics and performance of the network provider or operator of the content server, the location of the content server, the device used as a content player or historical connection data of said content player in connection with said content server, e.g. the accumulated experience based on past collected data by a monitoring system or external information source providing such data. Even though a content server may appear at a certain moment available and with sufficient band to serve the connecting client, the channel between the two may be congested or historically rendered unstable. Therefore, by assessing the channel and classifying the content servers based on the quality of the line or channel, it may be possible to select the best content server at any given time taking into account their individual pairing channel. Assessing the channel may be a parallel or external process running on clients that report data related to bandwidth, buffering, etc. This data may be considered (assessed) by a decision making algorithm executed at the fragment director.

In some embodiments said providing may comprise identifying a size of a buffer of the content player, calculating a number of fragments that their total size corresponds to the size of said buffer and providing a number of URLs that corresponds to said fragments so that the buffer of said content player is optimally used. By knowing the size of the buffer of the client, it may be possible to optimize the dispatch of URLs in batches equal to the size of the buffer, so that at any given moment the buffer of the client is optimally used. For example, a first set of URLs directed to a first content server may be used to fill a first portion of the buffer while a second set of URLs directed to a second content server may be used to fill a second portion of the buffer.

In some embodiments said fragmented content may comprise streaming media content. Streaming media content may not have a known size, as its duration may vary. However, the individual fragment sizes may be known, so it may still be possible to direct the client to a different content server for each fragment.

In some embodiments said streaming media content may comprise a main default fragmented content and an additional default fragmented content. For example, the main default fragmented content may be the requested content, such as a live event (e.g. a sporting event, a musical event etc.), while the additional default fragmented content may be advertising, embedded in the main default fragmented content at regular or irregular intervals. As the additional default fragmented content does not form part of the requested content, it may be identified during streaming. Then, in some embodiments, an alternative URL, or a number of alternative URLs, with additional custom fragmented content may be provided instead of a URL with additional default fragmented content. The size of said additional custom fragmented content may be substantially equal to the size of said additional default fragmented content. In the absence of additional default fragmented content the fragment director may add additional custom fragmented content to the main default fragmented content. For example, in case of an international event, custom advertisement may be embedded in the content that may be relevant to users in one geographic location than in another location. For example, the fragment director may add advertisement to a video-on-demand service. This may allow the end user to benefit from, otherwise costly, video-on-demand services by leveraging the cost of the video-on-demand service with the viewing of advertisements, introduced by the fragment director, at intervals during playback of the requested content. The fragment director may send a URL which points to an advertisement by directing a content player to a different content server, after a number of fragments have been downloaded, before reestablishing the dispatch of URLs with the requested video content. In other implementations, where additional default fragmented content, such as original advertisements, may be present, the fragment director may replace said original advertisements with custom advertisements or direct the content player to resources hosting custom advertisements instead of the original advertisements provided by the content server. Furthermore, the providers of the main default content may be different from the providers of the advertisements.

In some embodiments the requested fragmented content may comprise media content and metadata or additional content. For example, said media content may comprise video content and said additional content may comprise audio content and/or subtitle content. In one example, the main content may be the video content of a film and the additional content may be the subtitles of the film. Each fragment of the fragmented video content may have a corresponding URL while another URL may be provided for the subtitled content in a desired language. However, the providers of the video content may be different from the providers of the additional content. In some embodiments, the media content may be hosted in a first server and the metadata or additional content may be hosted in a second server. Therefore, the requested content may comprise of media content as well as additional content, that is, e.g. the video file with the subtitles in a certain language. Therefore, said providing may comprise compiling said requested fragmented content, hosting said requested fragmented content in a temporary location and providing the URL of said temporary location. In that way, a customized content may be generated for the particular client.

In another aspect a device for directing a fragmented content to a content player is disclosed. The device comprises electronic/computing means for receiving a request from the content player to deliver said fragmented content to said content player; electronic/computing means for identifying a list of one or more content servers hosting a copy of said fragmented content; electronic/computing means for identifying one or more URLs for each fragment of said fragmented content, each URL corresponding to at least one of said content servers; electronic/computing means for selecting at least a first content server or group of content servers from the list of content servers to deliver at least a first fragment or group of fragments based on a first set of directing criteria; electronic/computing means for selecting at least a second content server or group of content servers from the list of content servers to deliver at least a second fragment, or group of fragments based on a second set of directing criteria; and, electronic/computing means for providing the URLs of said at least first and second fragments or groups of fragments corresponding to the selected first and second content servers, respectively, to the content player. The at least first content server may be the best available content server or a group of best available content servers. The at least second content server may be a next best available content server or another group of available content servers. However, other criteria may apply, such as a weighted distribution of fragmented content between content servers or even a random distribution. In some implementations, the fragments may be distributed among a plurality of content servers. Furthermore, redundancy in the URLs provided may be anticipated. Therefore, the whole downloading process may be optimized as bandwidth issues may be resolved by balancing and/or switching between different content servers but also momentary lapses in the connection line between a content player and a particular content server may be resolved instantly by the provision of backup URLs for each fragment or for groups of fragments.

In another aspect a fragment director comprises a memory, configured to receive a list of available fragmented contents and associated content servers hosting said fragmented contents; one or more content server ports configured to assess traffic of a plurality of content servers a processor, configured to process said assessed traffic and classify content servers based on said monitored traffic, one or more content player ports configured to communicate with one or more content players, respectively, wherein the device is configured to receive a request from said one or more content players for a fragmented content and send, in response, at least one URL address for each fragment of said fragmented content based on said ranking.

In yet another aspect, a content player comprises a transmitter configured to send a request to a fragment director to deliver a fragmented content to said content player; a receiver, configured to receive a plurality of URLs from said fragment director, each URL corresponding to a fragment of said fragmented content in one of a plurality of content servers; a browser, configured to connect to one of the plurality of content servers using said URL to download said fragment. The content player is configured to send information regarding playback context to said fragment director at regular intervals or to an associated monitoring process. This may include user preferences, device characteristics, connection logs, etc. In case the content player provides the aforementioned information to a monitoring agent, said agent may provide aggregated information to the fragment director.

In yet another aspect a system comprises a fragment director is disclosed. The fragment director may have: a memory, said memory being configured to receive a list of fragmented content and associated content servers hosting said fragmented content; one or more content servers assessing modules configured to assess traffic of a plurality of content servers; a processor, configured to process said assessed traffic and classify content servers based on said assessed traffic; one or more content player communication ports configured to communicate with at least one content player. The fragment director may be configured to receive a request from said at least one content player for a fragmented content and send, in response, at least one URL address for each fragment of said fragmented content based on said classifying. The system may further comprise a plurality of content servers and a plurality of content players.

In yet another aspect, a computing device is disclosed. The computing device may comprise a memory and a processor. The memory may store computer program instructions executable by the processor, said instructions comprising functionality to execute a method of directing a fragmented content to a content player according to aspects disclosed herein.

In yet another aspect, a computer program product is disclosed. The computer program product comprises instructions to provoke that a fragment director implements a method of directing a fragmented content to a content player according to aspects disclosed herein. The computer program product may be stored in recording media or it may be carried by a carrier signal.

### BRIEF DESCRIPTION OF THE DRAWINGS

Non-limiting examples of the present disclosure will be described in the following, with reference to the appended drawings, in which:

FIG. 1 illustrates a block diagram of a fragmented content.

FIG. 2 illustrates a block diagram of an adaptive fragmented content.

FIG. 3 illustrates a balancing scenario according to an example.

FIG. 4 illustrates a block diagram of a fragment director according to an example.

FIG. 5 illustrates a flow diagram of a method of directing fragmented content according to an example.

### DETAILED DESCRIPTION

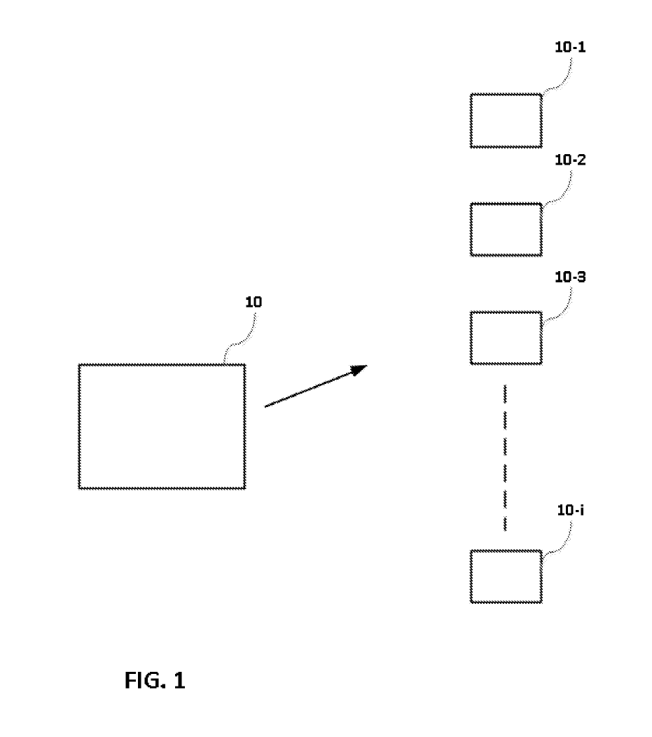

FIG. 1 illustrates a block diagram of a digital content. Content 10 is adaptive content, meaning that it may be fragmented and may comprise a number of fragments 10-1, 10-2, 10-3 to 10-i. the number of fragments may be bounded, as in the case of video on demand (VOD) or unbounded, as in the case of live streaming. For example, content 10 may be a in a format suitable to store video and audio, but also suitable to store subtitles and still images, such as an MPEG-4 Part 14 (.mp4) format. Content 10 may be segmented in small independent fragments, typically of 1 to 3 seconds. In case the fragment is a video unit (either file or byte-stream) it can, normally, be played independently by the content player. It shall contain at least a group of pictures or a multiple of it. A manifest file may describe which fragments belong to the stream, for instance in a playlist-like way, or it can simply indicate where fragments may be gathered from. In some examples, the manifest merely contains URLs that point to locations with triggering mechanisms that are configured to provide said content. In some implementations, the same manifest file may comprise a list of URLs, one URL for each fragment or a reference to the content. A manifest file typically originates from a content server. Consequently, the URLs in the manifest direct to the same content server where the manifest originates from. In that case it is not possible to change content server during playback as each content server only provides manifests directing to their own resources. Therefore, a manifest file is typically loaded on a client player and used to download the fragmented content from the content server where the URLs direct to. Although fragmented content may use any application layer protocol, typically special focus is put on HTTP-based protocols. Examples of HTTP-based protocols for non-adaptive content (video on demand) include the HTTP Progressive Download (PD) protocol. For adaptive content, both live content and video on demand, Microsoft Smooth Streaming (SS) protocol, Adobe HTTP Dynamic Streaming (HDS) protocol, Apple HTTP Live Streaming (HLS) protocol, Dynamic Adaptive Streaming over HTTP (DASH) protocol, only to name a few. In non-adaptive protocols a client player typically receives the requested content in a single byte-stream from the connected content server. In adaptive protocols the client player requests each fragment from the selected content server.

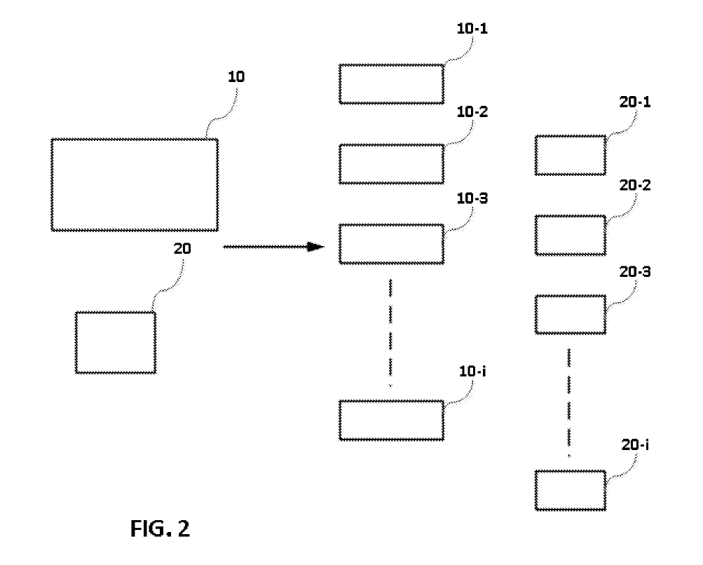

FIG. 2 illustrates a block diagram of an adaptive fragmented content. An adaptive fragmented content may reside in a plurality of forms in a content server. For example, it may be in single bitrate format (SBR) or in Multi-bitrate format (MBR). In MBR the content may be stored in different quality formats, e.g. resolutions, frame-rate, quantization step, bits per audio/video sample etc., at the same time in the same content server or in different but associated, through the manifest, content servers. In the example of FIG. 2, content 10 is high definition and content 20 is standard definition. Content 10 may comprise of fragments 10-1 to 10-i, while content 20 may comprise of fragments 20-1 to 20-i. However, a single manifest file may describe the fragments of each video quality in the stream and the corresponding URLs. As a result, an intelligent content player may adapt during streaming and scale up or down the quality of the content that is being downloaded based on the quality or the available bandwidth of the connection between the client player and the content server.

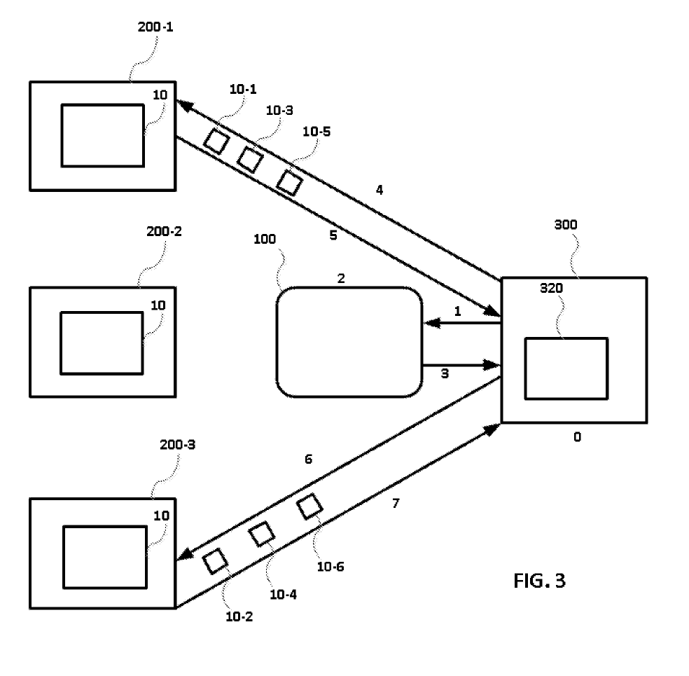

FIG. 3 illustrates a balancing scenario according to an example. A client player 300 sends a request for fragmented content 10 to fragment director 100. A client player may contain, for instance, a browser plugin in case it is required to send extra parameters to the fragment director. It may load a manifest and point to URLs for downloading the requested content. Additionally, it may comprise functionality for sending data about the playback experience, e.g. delay, bitrate etc., and, in general terms, any kind of data about the user's context, e.g. device, network, applications, etc. Such information may be sent directly to the fragment director or to an external provider of monitoring activities. Said external provider may then feed the fragment director algorithm with statistical or aggregated data received from the content players and/or the content servers if desired and in order to improve or enrich the decision making process. The fragment director 100 may identify a number of content servers 200-1, 200-2, 200-3 that host said requested content 10. Then, the fragment director 100 may evaluate each of the content servers 200-1 to 200-3 and the connection line between each of the content servers and/or the client player 300. Said evaluation may comprise the past experience of the content server and/or the past reporting of players. It may further comprise a momentary test of the connection between a first best candidate selected and the requesting content player. Then it may evaluate the buffer 320 of the content player to estimate the number of fragments that the buffer 320 may accommodate at any given time. In the example of FIG. 3, the buffer 320 may accommodate six (6) fragments of the content 10. Then the fragment director 100 may send a manifest comprising of 6 URLs to the client player 300. Alternatively, the fragment director may parse the whole manifest and the content player will handle the buffer replenishment accordingly. In yet other implementations, the fragment director 100 may send a plurality of modified sub-manifests at intervals to the content player. Therefore, each sub-manifest may include URLs that match more closely the actual state of the network. In the example shown in FIG. 3, the manifest may include at least 3 URLs that direct to content server 200-1 and at least 3 URLs that direct to content server 200-3. That means that the fragment director has identified that the optimum balancing scenario at that moment may require the use of 2 (200-1, 200-3) out of the 3 available content servers and a distribution of URLs between these two content servers. One skilled in the art may appreciate that, according to other scenarios, a fragment director may direct traffic to a first CDN at the beginning and for a number of fragments and then switch to another one for a second number of fragments instead of alternating between CDNs. In other examples a weight function may direct more URLs to a first CDN and less to a second CDN. In yet other examples, more than two CDNs may be used in a distributed manner, either weighted or random. In the example of FIG. 3, the fragments 10-1, 10-3, 10-5 are requested from content server 200-1 and the fragments 10-2, 10-4, 10-6 are requested from the content server 200-3. The subsequent URLs may be sent in batches of 6 or individually to fill the slots of the buffer as the content is being downloaded and played. This dispatch may be in the form of individual URLs, or in the form of a modified complete manifest including the URLs or in the form of a plurality of sub-manifests, each corresponding to a group of fragments. In that way, the effective throughput of a multimedia session may be maximized as a plurality of connections are used to fill up the buffer.

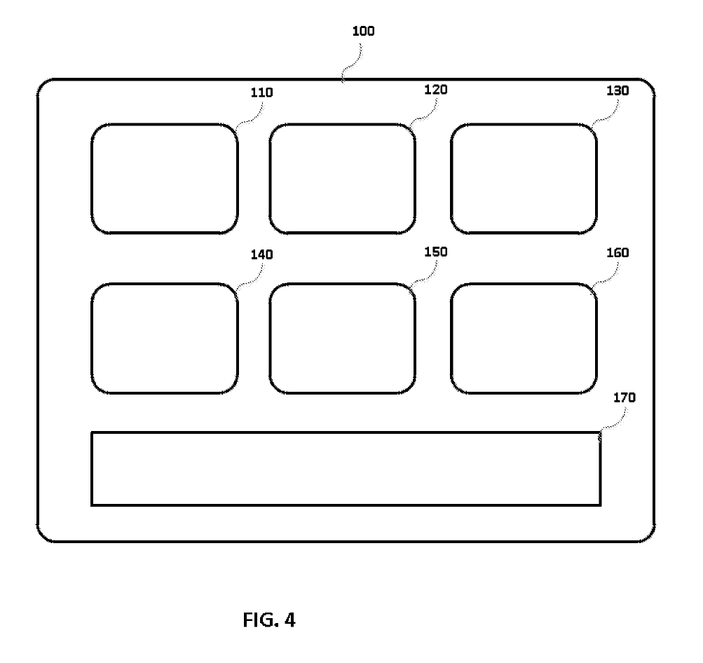

FIG. 4 is a block diagram of an example fragment director. It may comprise a content server managing module 110, a constraints module 120, a policies module 130, a decision making module 140, a security module 150, a protocol transmoding module 160 and a network interface 170, e.g. an HTTP interface. In other examples the fragment director may comprise more or less modules or a certain module may implement the functionality of two or more modules as described herein. The content server managing module 110 may be the controller of all the processes and responsible of initializing the balancer 100. The constraints module 120 may specify the different constraints (e.g. thresholds and preferences) to be considered during the decision-making process. The policies module 130 may specify the different policies of configuration of the balancer 100 that will be considered during the decision-making process. The constraints module 120 may specify the different constraints (e.g. thresholds and preferences) to be considered during the decision-making process. The content server managing module 130 may be the controller of all the processes and responsible of initializing the balancer 100. The decision making module 140 is in charge of calculating which may be the best CDN for a given request. A request may contain a URL to a group of segments (Manifest) or a URL to a specific segment (fine granularity). This module may execute a specific algorithm that carries out the selection of the best CDN. Module 140 may communicate with the policies module 110 and with the constraints module 120. The output of module 140 is the chosen best CDNs according to the constraints and policies. It may include a main CDN and backup ones with URLs selected according to the requirements and the characteristics of a request, which may or may not be dispatched to the content player. Ideally, it may also consider the history of the behavior of CDNs in the past. The security module 150 is in charge of evaluating, if desired, of secure requests to the fragment director 100. The content player may send a preconfigured token or use specific certificates, so that every incoming request may be validated—or not—and processed accordingly. In addition, the security module 150 may be able to validate—or not—incoming requests from content players according to any security rule. These security rules may be related to the location of the content player location. For example, they may include filtering according to forbidden or allowed territories, countries or cities, type of device, such as desktop computer, mobile device, tablet, smart TV, etc., IP address, such as whitelisted or blacklisted IP address or range of IP addresses), etc. or any other specific criteria. In some implementations the fragment director may further include the protocol transmoding module 160. The protocol transmoding module 160 may be an optional module able to transform on the fly segments and manifests in order to serve a content or segment of video in a specific format. Thanks to this module, the fragment director 100 may switch from one protocol/format to another in order to meet the user requirements and capabilities. The role of HTTP interface 170 is to attend HTTP requests. These HTTP requests may be generated by the clients running the plug-in/players or implementing a communication interface with the fragment director. Specifically, the requests may specify the content or segments to load at any given time. The volume of requests per second to be received by the HTTP interface may be significantly high. For this reason, this interface needs to be fast enough to attend thousands of requests per second in a stable way.

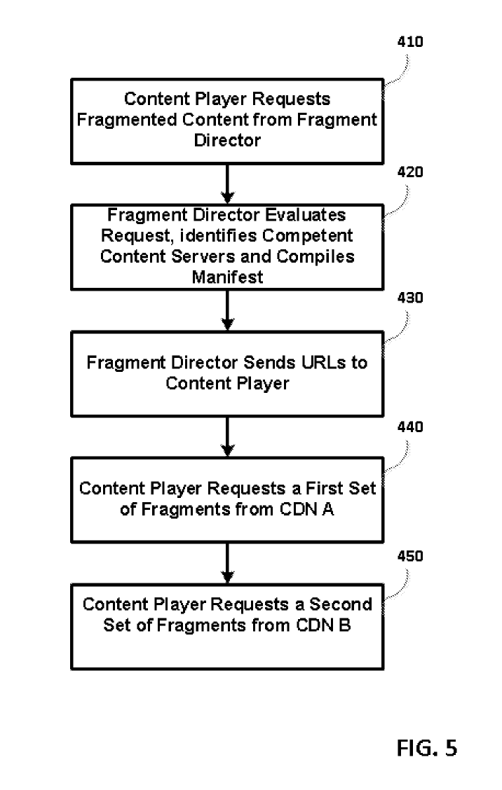

FIG. 5 is a flow diagram of a method of directing fragmented content according to an example. In a first step 410, a fragmented content is requested by a content player from a fragment director. In a next step 420, the fragment director evaluates the request, identifies competent content servers and compiles a manifest with corresponding URLs, according to the status of the respective content servers. Then, in step 430, the fragment director sends the URLs to the content player. URLs may be sent using any kind of response message using any kind of protocol and format, as mentioned herein. The content player, in step 440, requests a first set of fragments from a first content server (CDN A) and a second set of fragments, in step 450, from a second content server (CDN B).

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A method of directing a fragmented content to a content player, comprising:
receiving a request at a fragment director from the content player to deliver said fragmented content to said content player;
identifying a list of a plurality of content servers hosting a copy of said fragmented content;
identifying one or more Universal Resource Locators (URLs) for each fragment of said fragmented content, each URL corresponding to at least one of said content servers;
selecting at least a first content server or group of content servers from the list of content servers to deliver at least a first fragment or group of fragments based on a first set of directing criteria;
selecting at least a second content server or group of content servers from the list of content servers to deliver at least a second fragment or group of fragments based on a second set of directing criteria; and
providing the URLs of said at least first and second fragments or groups of fragments corresponding to the selected at least first and second content servers or groups of content servers, respectively, to the content player.

2. The method according to claim 1, wherein said fragmented content is one or both of video content and audio content.

3. The method according to claim 1, wherein said selecting based on directing criteria comprises:
assessing the traffic of the plurality of content servers or groups of content servers; and
classifying the content servers or groups of content servers based at least on said assessed traffic.

4. The method according to claim 1, wherein said selecting based on directing criteria comprises:
assessing the connection channel between said content player and a network service provider that gives access to the content player to the content server or groups of content servers; and
classifying the plurality of content servers based at least on said assessing of the connection line between each content server and the content player.

5. The method according to claim 1, wherein said providing comprises:
identifying a size of a buffer of the content player;
calculating a number of fragments that their total size corresponds to the size of said buffer; and
providing a number of URLs that corresponds to said fragments so that the buffer of said content player is optimally used.

6. The method according to claim 1, wherein said fragmented content comprises streaming media content.

7. The method according to claim 6, wherein said streaming media content comprises a main default fragmented content and an additional default fragmented content.

8. The method according to claim 7, wherein said providing the URLs comprises:
identifying an additional fragmented content in the streaming media content; and
providing at least one URL with additional custom fragmented content instead of a URL with additional default fragmented content, wherein the size of said additional custom fragmented content is substantially equal to the size of said additional default fragmented content.

9. The method according to claim 1, wherein the requested fragmented content comprises media content and metadata or additional content.

10. The method according to claim 9, wherein when said media content is hosted in a first server and said metadata or additional content is hosted in a second server, said providing comprises:
compiling said requested fragmented content;
hosting said requested fragmented content in a temporary location; and
providing the URL of said temporary location.

11. The method according to claim 9, wherein said media content comprises video content and said metadata or additional content comprises one or both of audio content and subtitle content.

12. The method according to claim 1, wherein the first set of criteria comprises the second set of criteria.

13. The method according to claim 1, wherein at least the first or the second set of criteria comprises a weighted distribution criterion between content servers based on a past performance of the content servers.

14. The method according to claim 1, wherein at least the first or the second set of criteria comprises a random distribution criterion between the content servers.

15. The method according to claim 1, wherein said receiving a request comprises:
receiving a secure request; and
validating said secure request.

16. A fragment director comprising:
a memory, configured to receive a list of available fragmented content and associated content servers hosting said fragmented content;
one or more content server ports configured to assess traffic of a plurality of content servers;
a processor, configured to process the assessed traffic and classify content servers based on the assessed traffic; and
one or more content player ports configured to communicate with at least one content player;
wherein the fragment director is configured to receive a request from said at least one content player for a fragmented content and send, in response, at least a URL address for each fragment of said fragmented content based on the classifying of content servers.

17. A system comprising:
a fragment director according to claim 16;
a plurality of content servers;
a plurality of content players, said content players:
configured to send a request to the fragment director to deliver a fragmented content to said content player;
configured to receive a plurality of URLs from said fragment director, each URL corresponding to a fragment of said fragmented content in one of the plurality of content servers; and
a browser, configured to connect to said one of the plurality of content servers using said URLs to download said fragments.

18. The system according to claim 17,
wherein the content player is configured to send information regarding playback context to said fragment director at regular intervals.

19. The system according to claim 17, wherein the plurality of content servers comprises a plurality of content delivery/distribution servers (CDNs).

20. A computing device comprising a memory and a processor, wherein the memory stores computer program instructions executable by the processor, said instructions comprising functionality to execute a method of directing a fragmented content to a content player according to claim 1.
